(19) United States
(12) Patent Application Publication
(10) Pub. No.: US 2026/0195656 A1
(43) Pub. Date: Jul. 9, 2026

(54) TRAINING AND SELECTION OF MODELS OF AN ENSEMBLE MODEL

(71) Applicant: INTERNATIONAL BUSINESS MACHINES CORPORATION, ARMONK, NY (US)

(72) Inventors: JUN QI ZHANG, XI'AN (CN); LEI TIAN, XI'AN (CN); HAN ZHANG, XI'AN (CN); RONG HONG WAN, XI'AN (CN); LI NA WANG, XI'AN (CN)

(21) Appl. No.: 19/011,518

(22) Filed: Jan. 6, 2025

(51) Int. Cl. G06N 20/20

(52) U.S. Cl. CPC G06N 20/20

(57) ABSTRACT

Training and selection of models of an ensemble model, including: generating an ensemble model comprising a plurality of models by repeatedly generating a respective model for inclusion in the ensemble model, wherein generating the respective model comprises: training the respective model using a training data set; generating, for the respective model, a plurality of predictions based on an evaluation data set; and identifying, based on the plurality of predictions, from the evaluation data set, for the respective model, a subset of correctly predicted data and a subset of incorrectly predicted data.

### BACKGROUND

The present disclosure relates to methods, apparatus, and products for training and selection of models of an ensemble model.

### SUMMARY

According to embodiments of the present disclosure, various methods, systems and products for training and selection of models of an ensemble model are described herein. In some aspects, training and selection of models of an ensemble model includes generating an ensemble model comprising a plurality of models by repeatedly generating a respective model for inclusion in the ensemble model, wherein generating the respective model comprises: training the respective model using a training data set; generating, for the respective model, a plurality of predictions based on an evaluation data set; identifying, based on the plurality of predictions, from the evaluation data set, for the respective model, a subset of correctly predicted data and a subset of incorrectly predicted data; wherein the training data set for a first model of the ensemble model comprises an initial training data set and the evaluation data set for the first model comprises the initial training data set and a testing data set; and wherein the training data set and the evaluation data set for each model of the ensemble model other than the first model comprises the subset of incorrectly predicted data of a last generated model of the ensemble model. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth a block diagram of an example computing environment for training and selection of models of an ensemble model in accordance with some embodiments of the present disclosure.

FIG. 2 sets forth an example process flow diagram for training and selection of models of an ensemble model in accordance with some embodiments of the present disclosure.

FIG. 3 sets forth an example process flow diagram for selecting models from an ensemble model generated in accordance with some embodiments of the present disclosure.

FIG. 4 sets forth a flowchart of an example method of training and selection of models of an ensemble model in accordance with some embodiments of the present disclosure.

FIG. 5 sets forth a flowchart of another example method of training and selection of models of an ensemble model in accordance with some embodiments of the present disclosure.

FIG. 6 sets forth a flowchart of another example method of training and selection of models of an ensemble model in accordance with some embodiments of the present disclosure.

FIG. 7 sets forth a flowchart of another example method of training and selection of models of an ensemble model in accordance with some embodiments of the present disclosure.

FIG. 8 sets forth a flowchart of another example method of training and selection of models of an ensemble model in accordance with some embodiments of the present disclosure.

### DETAILED DESCRIPTION

Trained models, such as trained machine learning models, may be used to generate predictions based on some input data. For some data sets with particular characteristics, a single model may not be useful in generating predictions from that data set. For example, a single model may have a low prediction accuracy for some data sets. As another example, a single model may not be accurate when processing highly dispersed data. To address these concerns, an ensemble model may be used that includes multiple subcomponent models. A particular model included in the ensemble model may be selected to provide predictions based on some input data. Accordingly, the component models of the ensemble model should be trained for high accuracy. Moreover, the most suitable component model of the ensemble model should be selected so as to provide the most accurate predictions for some input data.

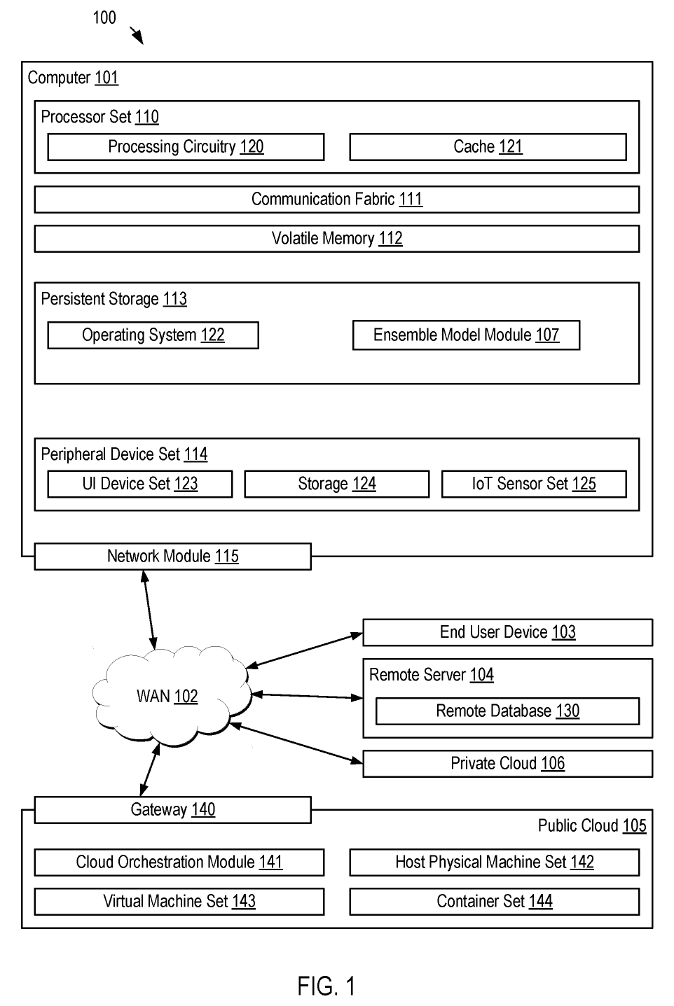

With reference now to FIG. 1, shown is an example computing environment according to aspects of the present disclosure. Computing environment 100 contains an example of an environment for the execution of at least some of the computer code involved in performing the various methods described herein, such as the ensemble model module 107. In addition to the ensemble model module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the ensemble model module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in the ensemble model module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

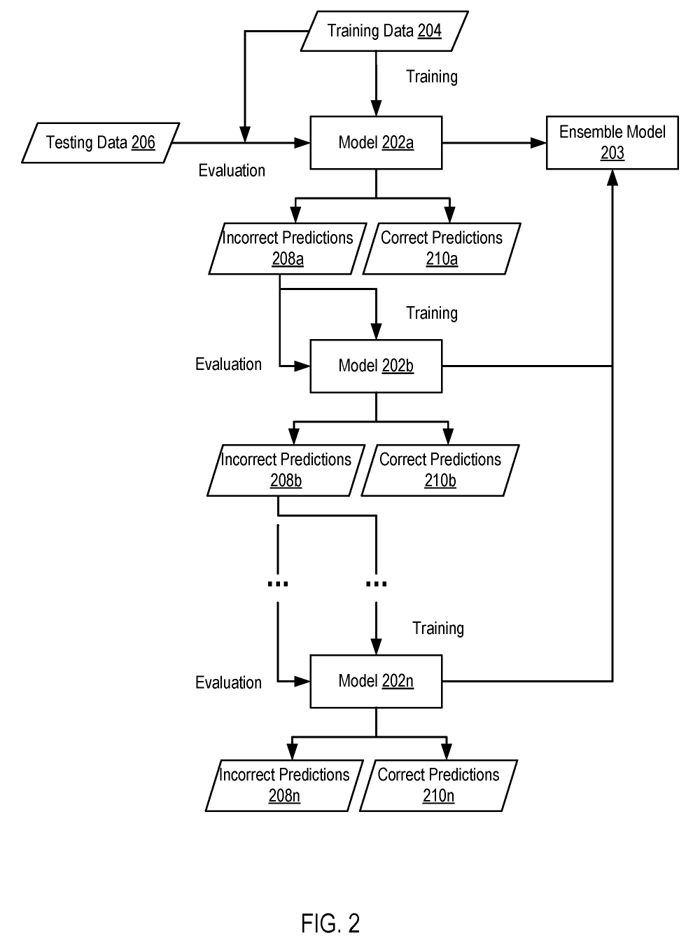

FIG. 2 sets forth an example process flow diagram for training and selection of models of an ensemble model in accordance with some embodiments of the present disclosure. In the example process flow of FIG. 2, a model 202a to be included in the ensemble model 203 is trained using a set of training data 204. The model 202a may include any trained model, such as trained machine learning model, as can be appreciated. The model 202a is then evaluated using a data set that includes the training data 204 as well as additional testing data 206. Evaluating the model 202a includes generating predictions using the model 202a based on each data sample in the training data 204 and the testing data 206. Here, the model 202a may perform some predictions correctly (e.g., provide, as output, the correct prediction value) and may perform some predictions incorrectly. Accordingly, the input data for evaluating the model 202a (e.g., the combined testing data 204 and testing data 206) may be subdivided into two data sets, data that was incorrectly predicted, shown as incorrect predictions 208a, and data that was correctly predicted, shown as correct predictions 210a.

The data incorrectly predicted by the model 202a (e.g., the incorrect predictions 208a) is then used as training data for a model 202b. Here, the model 202b is evaluated using similar approaches as are set forth above as evaluating the model 202a, instead using the incorrect predictions 208a as the input data for evaluating the model 202b. Again, the input data for evaluating the model 202b (e.g., the incorrect predictions 208a) may be subdivided into two data sets, data that was incorrectly predicted, shown as incorrect predictions 208b, and data that was correctly predicted, shown as correct predictions 210b.

This process of training models using the incorrect predictions from the previously trained and evaluated is repeatedly performed until some termination condition is satisfied, resulting in a final model 202n for inclusion in the ensemble model 203. In some embodiments, the final model 202n may be evaluated using similar approaches as are set forth above to generate incorrect predictions 208n and correct predictions 210n. The termination condition may include a variety of termination conditions as can be appreciated that may be defined or configured based on various design or engineering considerations. For example, in some embodiments, the termination condition may include a number of incorrect predictions 208a,b-n from evaluating a model 202a,b-n falling below a threshold. As another example, in some embodiments, the termination condition may include generating up to a threshold number of models 202a,b-n for inclusion in the ensemble model 203.

In some embodiments, an amount of data in incorrect predictions 208a,b-n produced from evaluating a model 202a,b-n may fall below some threshold amount of data necessary for training another model 202a,b-n. Accordingly, in some embodiments, one or more synthetic data records may be added to these incorrect predictions 208a,b-n to supplement a training data set for another model 202a,b-n. For example, assuming a set of incorrect predictions 208a,b-n, one or more synthetic data records may be added based on a statistical distribution or statistical analysis of the set of incorrect predictions 208a,b-n. For example, the synthetic data records may be generated to conform to a particular distribution of the incorrect predictions 208a,b-n, to keep various aggregate values of the set of incorrect predictions 208a,b-n (e.g., the minimum, median, average, maximum, and the like) within some tolerance range, and the like. In some embodiments, the termination condition may include training a model 208a,b-n using some amount of synthetic data. The termination condition may also include other conditions as can be appreciated.

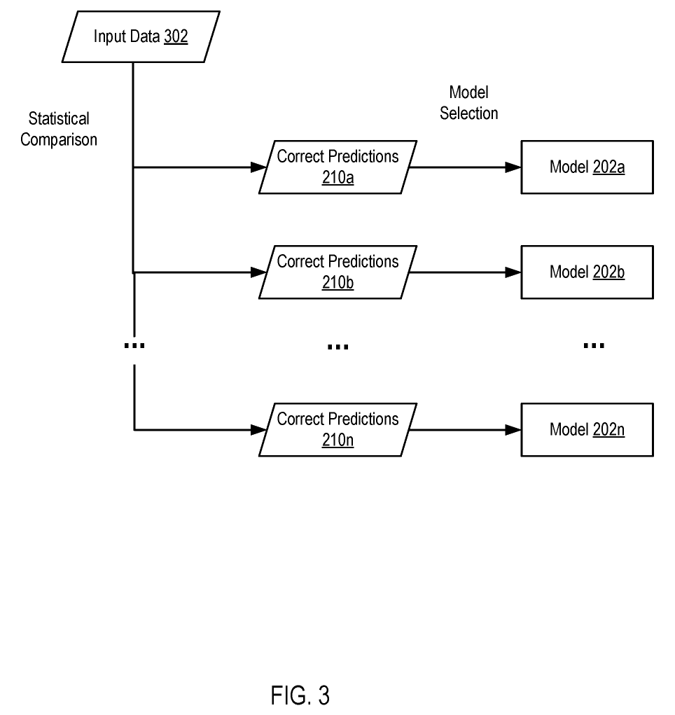

The resulting ensemble model 203 includes multiple models 202a,b each having an associated set of correct predictions 210a,b-n. When some input data is to be processed by the ensemble model 203, a particular model 202a,b-n should be selected to process the input data (e.g., to generate predictions). Accordingly, FIG. 3 sets forth an example flow diagram for model selection from an ensemble model generated according to the approaches set forth herein. Here, a particular model 202a,b-n is to be selected for processing input data 302. In some embodiments, this may include performing a statistical comparison of the input data 302 to the correct predictions 201a,b-n. For example, in some embodiments, a statistical distribution may be calculated for each correct prediction 210a,b-n data set. A statistical distribution may include various aggregate values describing the data in the correct prediction 210a,b-n data set. For example, such aggregate values may include an average, a median, a maximum, a minimum, a variance, a standard deviation, and the like.

A statistical distribution may then be calculated as a function of the input data 302. The statistical distribution of the input data 302 may then be compared to the statistical distributions of the correct predictions 210a,b-n to identify a correct prediction 210a,b-n with a statistical distribution having a highest degree of similarity to the statistical distribution of the input data 302. Similarity may be calculated, for example, as a distance in multidimensional space using each value in the statistical distribution as a different dimension. Such a distance may be calculated using any multidimensional distance function as can be appreciated, such as Euclidian distance, cosine distance, and the like. Other approaches may also be used when comparing statistical distributions to identify similar statistical distributions. The model 202a,b-n corresponding to the identified correct prediction 210a,b-n data set is then selected for processing the input data 302. For example, where the statistical distribution of the input data 302 is most similar to the statistical distribution of the correct prediction 210b data set, the model 20b may be selected for processing the input data 302.

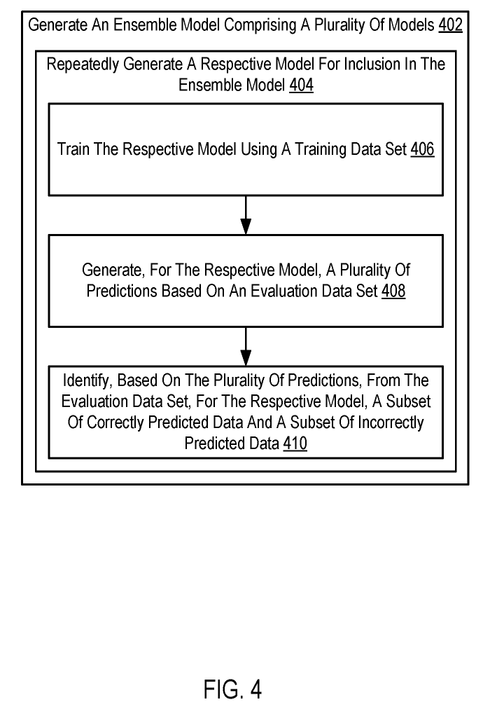

For further explanation, FIG. 4 sets forth a flowchart of an example method of training and selection of models of an ensemble model in accordance with some embodiments of the present disclosure. The method of FIG. 4 may be performed, for example, using the ensemble model module 107 of FIG. 1. The method of FIG. 4 includes generating 402 an ensemble model comprising a plurality of models. The ensemble model includes multiple models such that any of the multiple models may be used when processing some input data. This may be used, for example, to use a particular model to generate predictions based on characteristics of the input data.

As the ensemble model includes multiple models, generating 402 the ensemble model includes generating multiple models for inclusion in the ensemble model. Accordingly, in some embodiments, generating 402 the ensemble model includes repeatedly generating 404 a respective model for inclusion in the ensemble model. Each iteration of generating 404 the respective model may include multiple steps for training and evaluating the respective model. For example, in some embodiments, generating 404 the respective model may include training 406 the respective model using a training data set. In some embodiments, for the first model to be included in the ensemble model, the training data set for the respective model may include some initially selected or defined corpus of training data. In some embodiments, as will be described in further detail below, the training data for subsequent models beyond the first model may include a set of incorrectly predicted data for the sequentially preceding (e.g., the last generated) model generated for inclusion in the ensemble model. For example, the training data set for a first model may include an initial training data set. The training data set for a second model may include the incorrectly predicted data from the first model. The training data set for a third model may include the incorrectly predicted data from the second model, and so forth.

In some embodiments, generating 404 the respective model for inclusion in the ensemble model may also include generating 408, for the respective model, a plurality of predictions based on an evaluation data set. In other words, in some embodiments, the evaluation data set may be provided as input to the respective model in order to generate, as output, the plurality of predictions. In some embodiments, for the first model to be included in the ensemble model, the evaluation data set may include the initial training data set (e.g., the training data for the first model) and a set of additional testing data. In some embodiments, as will be described in further detail below, the evaluation data set for subsequent models beyond the first model may include a set of incorrectly predicted data for the sequentially preceding (e.g., the last generated) model generated for inclusion in the ensemble model. In other words, in some embodiments, both the training data set and the evaluation data set for subsequent models beyond the first model may be identical. For example, the evaluation data set for the first model may include the initial training data set and additional testing data. The evaluation data set for the second model may include the incorrectly predicted data from the first model. The evaluation data set for the third model may include the incorrectly predicted data from the second model, and so forth.

In some embodiments, generating 404 the respective model for inclusion in the ensemble model may also include identifying 410, based on the plurality of predictions, from the evaluation data set, for the respective model, a subset of correctly predicted data and a subset of incorrectly predicted data. Assume that, for each portion or sample of data in the evaluation data set, a correct prediction is known (e.g., an expected value that should be output by the respective model). Accordingly, the evaluation data may be subdivided into two subsets: a subset of correctly predicted data (e.g., where the generated 408 prediction matches the expected value) and a subset of incorrectly predicted data (e.g., where the generated 408 prediction does not match the expected value). As is set forth above, the incorrectly predicted data for a given model may be used as the training data set and evaluation data set for the next model to be generated. As will be described in further detail below, the correctly predicted data for a given model may be used when selecting a model from the ensemble model to process (e.g., to generate predictions for) some input data.

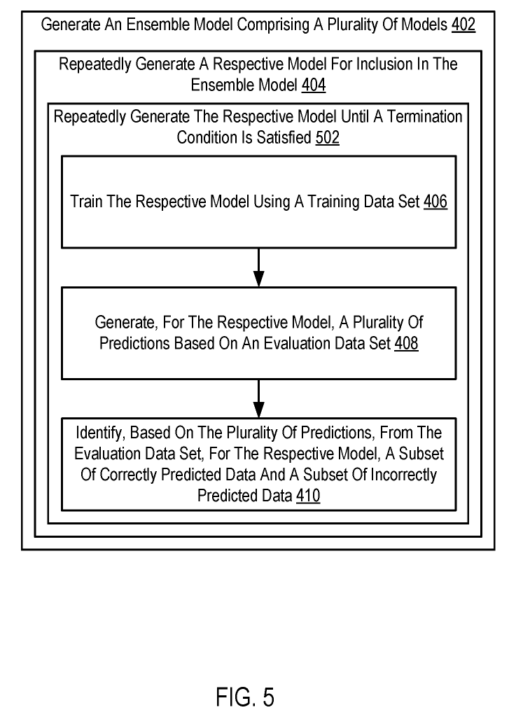

For further explanation, FIG. 5 sets forth a flowchart of another example method of training and selection of models of an ensemble model in accordance with some embodiments of the present disclosure. The method of FIG. 5 is similar to FIG. 4 in that the method of FIG. 5 also includes: generating 402 an ensemble model comprising a plurality of models by repeatedly generating 404 a respective model for inclusion in the ensemble model, including: training 406 the respective model using a training data set; generating 408, for the respective model, a plurality of predictions based on an evaluation data set; and identifying 410, based on the plurality of predictions, from the evaluation data set, for the respective model, a subset of correctly predicted data and a subset of incorrectly predicted data.

The method of FIG. 5 differs from FIG. 4 in that repeatedly generating 404 a respective model for inclusion in the ensemble model also includes repeatedly generating 502 the respective model for inclusion in the ensemble model until a termination condition is satisfied. The termination condition may include a variety of termination conditions as can be appreciated that may be defined or configured based on various design or engineering considerations. For example, in some embodiments, the termination condition may include an amount of incorrectly predicted data for a given model falling below a threshold. As another example, in some embodiments, the termination condition may include generating 502 up to a threshold number of models for inclusion in the ensemble model 203. As a further example, in some embodiments, the termination condition may include training a given model using training data that includes some amount of synthetic data. Other termination conditions are also contemplated within the scope of the present disclosure.

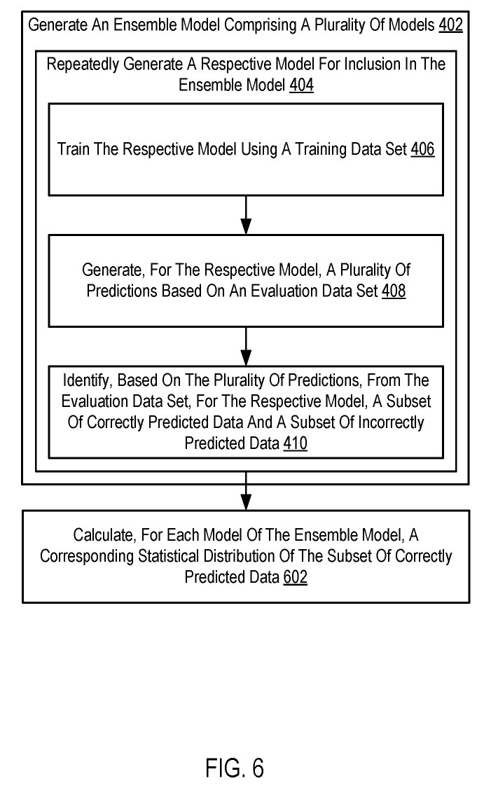

For further explanation, FIG. 6 sets forth a flowchart of another example method of training and selection of models of an ensemble model in accordance with some embodiments of the present disclosure. The method of FIG. 6 is similar to FIG. 4 in that the method of FIG. 6 also includes: generating 402 an ensemble model comprising a plurality of models by repeatedly generating 404 a respective model for inclusion in the ensemble model, including: training 406 the respective model using a training data set; generating 408, for the respective model, a plurality of predictions based on an evaluation data set; and identifying 410, based on the plurality of predictions, from the evaluation data set, for the respective model, a subset of correctly predicted data and a subset of incorrectly predicted data.

The method of FIG. 6 differs from FIG. 4 in that the method of FIG. 6 also includes calculating 602, for each model of the ensemble model, a corresponding statistical distribution of the subset of correctly predicted data. A statistical distribution of a given data set may include various aggregate values describing the data set. For example, such aggregate values may include an average, a median, a maximum, a minimum, a variance, a standard deviation, and the like. Accordingly, a set of one or more of these values may be calculated for each set of correctly predicted data for each model included in the ensemble model. As will be described in further detail below, this may be useful when selecting a particular model from the ensemble model to process some input data.

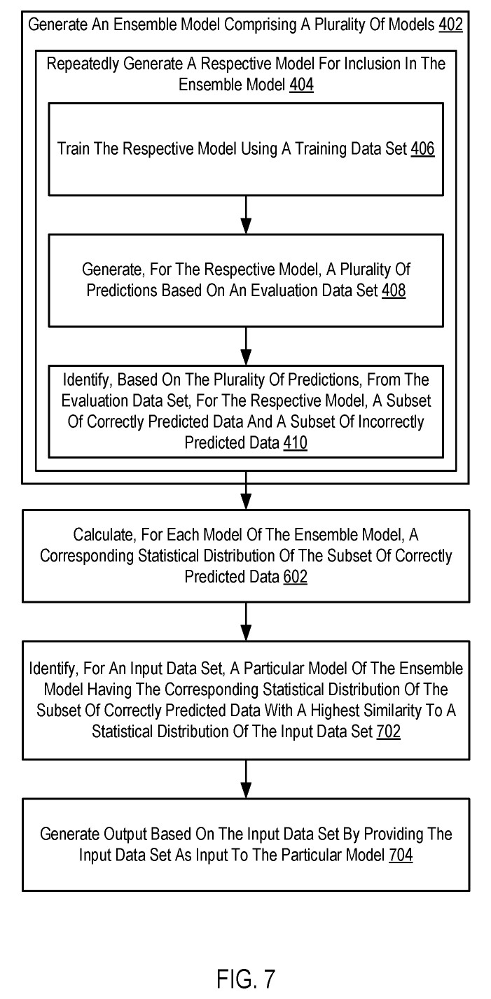

For further explanation, FIG. 7 sets forth a flowchart of another example method of training and selection of models of an ensemble model in accordance with some embodiments of the present disclosure. The method of FIG. 7 is similar to FIG. 4 in that the method of FIG. 7 also includes: generating 402 an ensemble model comprising a plurality of models by repeatedly generating 404 a respective model for inclusion in the ensemble model, including: training 406 the respective model using a training data set; generating 408, for the respective model, a plurality of predictions based on an evaluation data set; and identifying 410, based on the plurality of predictions, from the evaluation data set, for the respective model, a subset of correctly predicted data and a subset of incorrectly predicted data; and calculating 602, for each model of the ensemble model, a corresponding statistical distribution of the subset of correctly predicted data.

The method of FIG. 7 differs from FIG. 6 in that the method of FIG. 7 also includes identifying 702, for an input data set, a particular model of the ensemble model having the corresponding statistical distribution of the subset of correctly predicted data with a highest similarity to a statistical distribution of the input data set. The input data set may include a data set from which predictions will be generated by the ensemble model. Accordingly, in some embodiments, a particular model should be selected or identified 702 from the ensemble model to use in processing the input data.

For example, in some embodiments, identifying 702 the particular model may include calculating a statistical distribution for the input data. Calculating the statistical distribution for the input data may be performed according to similar approaches as are set forth above with respect to calculating 602, for each model of the ensemble model, a corresponding statistical distribution of the subset of correctly predicted data. For example, in some embodiments, a set of aggregate values such as an average, a minimum, a maximum, a standard deviation, a variance, a median, and the like may be calculated as the statistical distribution of the input data. The statistical distribution of the input data may then be compared to the statistical distributions of the subsets of correctly predicted data to identify subset of correctly predicted data having a statistical distribution with highest degree of similarity to the statistical distribution of the input data.

Similarity for statistical distributions may be calculated, for example, as a distance in multidimensional space using each value in the statistical distribution as a different dimension. Such a distance may be calculated using any multidimensional distance function as can be appreciated, such as Euclidian distance, cosine distance, and the like. Other approaches may also be used when comparing statistical distributions to identify similar statistical distributions. The model corresponding to the identified subset of correctly predicted data is then identified 702 for processing the input data. Accordingly, the method of FIG. 7 also includes generating 704 output based on the input data set by providing the input data set as input to the particular model (e.g., the identified 702 particular model). For example, the output of the particular model may include one or more predictions based on the input data set.

Readers will appreciate that the approaches set forth above for identifying a particular model and generating 704 output by the particular model may be repeatedly performed. For example, in some embodiments, a larger data set may be subdivided into different component data sets. Each component data set may be used as an input data set described above. Thus, rather than select a single model for processing the larger data set, different models may be selected from the ensemble model for processing subsets of the larger data set based on the characteristics of each subset of the larger data set.

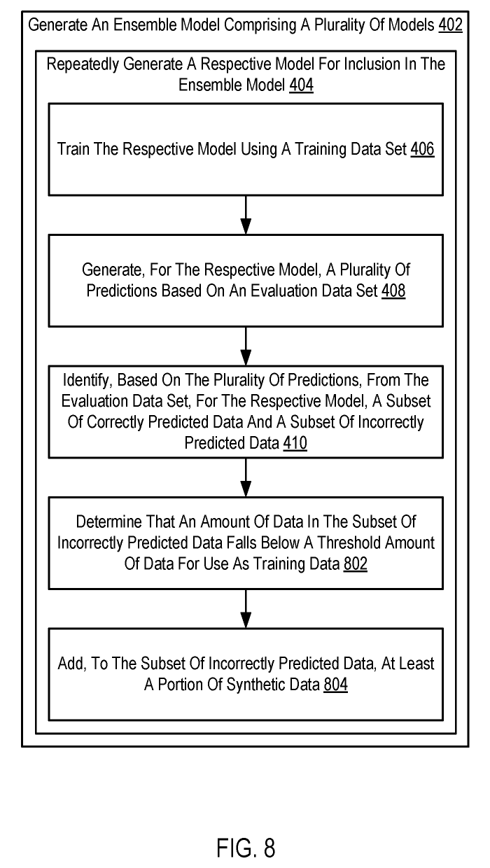

For further explanation, FIG. 8 sets forth a flowchart of another example method of training and selection of models of an ensemble model in accordance with some embodiments of the present disclosure. The method of FIG. 8 is similar to FIG. 4 in that the method of FIG. 8 also includes: generating 402 an ensemble model comprising a plurality of models by repeatedly generating 404 a respective model for inclusion in the ensemble model, including: training 406 the respective model using a training data set; generating 408, for the respective model, a plurality of predictions based on an evaluation data set; and identifying 410, based on the plurality of predictions, from the evaluation data set, for the respective model, a subset of correctly predicted data and a subset of incorrectly predicted data.

The method of FIG. 8 differs from FIG. 4 in that repeatedly generating 404 the respective model for inclusion in the ensemble model also includes determining 802 that an amount of data in the subset of incorrectly predicted data (e.g., for a given generated 404 model) falls below a threshold amount of data for use as training data. Readers will appreciate that, as the approaches set forth herein rely on training and evaluating models using a subset of incorrectly predicted data from a previous model, the amount of data used to train and evaluate each model will decrease over time. Eventually, this may cause the amount of training and evaluation data sets for a given model to be of a size that, once subdivided into correctly and incorrectly predicted data sets, the resulting incorrectly predicted data set may be too small to be useful in training another model for the ensemble model. This threshold amount may include a predefined amount, a configurable amount, a dynamically calculated amount, or another amount as can be appreciated.

Accordingly, in order to allow another model to be generated 404 for inclusion in the ensemble model, generating 404 the respective model for inclusion in the ensemble model also includes adding 804, to the subset of incorrectly predicted data, at least a portion of synthetic data (e.g., one or more synthetically generated data records). This synthetic data supplements the subset of incorrectly predicted data to serve as training and evaluation data for the next model to be generated. In some embodiments, the amount of synthetic data to be added 804 may include an amount such that the amount, when combined with the amount of incorrectly predicted data, meets or exceeds the threshold amount of data for use as training data.

For example, assuming a subset of incorrectly predicted data, one or more synthetic data records may be added based on a statistical distribution or statistical analysis of the subset of incorrectly predicted data. The statistical distribution of the subset of incorrectly predicted data may be calculated according to similar approaches as are set forth above. For example, in some embodiments, the synthetic data records may be generated to conform to a particular distribution shape or model of the subset of incorrectly predicted data. As another example, in some embodiments, the synthetic data records may be generated to keep various aggregate values of the statistical distribution of the subset of incorrectly predicted data within some tolerance range. Other approaches may also be used when adding 804 at least a portion of synthetic data to the subset of incorrectly predicted data.

Readers will appreciate that the approaches set forth herein improve the efficiency and accuracy of models trained for inclusion in an ensemble model. As different models may by selected based on the characteristics of data to be processed, the selected model will have produced a set of completely accurate predictions from data having similar characteristics to the input data to be processed. This improves the accuracy of predictions produced by the ensemble model, improving system utility and performance.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating an ensemble model comprising a plurality of models by repeatedly generating a respective model for inclusion in the ensemble model, wherein generating the respective model comprises:
training the respective model using a training data set;
generating, for the respective model, a plurality of predictions based on an evaluation data set;
identifying, based on the plurality of predictions, from the evaluation data set, for the respective model, a subset of correctly predicted data and a subset of incorrectly predicted data;
wherein the training data set for a first model of the ensemble model comprises an initial training data set and the evaluation data set for the first model comprises the initial training data set and a testing data set; and
wherein the training data set and the evaluation data set for each model of the ensemble model other than the first model comprises the subset of incorrectly predicted data of a last generated model of the ensemble model.

2. The computer-implemented method of claim 1, wherein repeatedly generating the respective model comprises repeatedly generating the respective model until a termination condition is satisfied.

3. The computer-implemented method of claim 1, further comprising calculating, for each model of the ensemble model, a corresponding statistical distribution of the subset of correctly predicted data.

4. The computer-implemented method of claim 3, further comprising identifying, for an input data set, a particular model of the ensemble model having the corresponding statistical distribution of the subset of correctly predicted data with a highest similarity to a statistical distribution of the input data set.

5. The computer-implemented method of claim 4, further comprising generating output based on the input data set by providing the input data set as input to the particular model.

6. The computer-implemented method of claim 1, wherein generating the respective model comprises:
determining that an amount of data in the subset of incorrectly predicted data falls below a threshold amount of data for use as training data; and
adding, to the subset of incorrectly predicted data, at least a portion of synthetic data.

7. The computer-implemented method of claim 6, wherein the at least a portion of synthetic data is based on a statistical distribution of the subset of incorrectly predicted data.

8. A computer system comprising:
a processor set;
one or more computer-readable storage media; and
program instructions stored on the one or more storage media to cause the processor set to perform operations comprising:
generating an ensemble model comprising a plurality of models by repeatedly generating a respective model for inclusion in the ensemble model, wherein generating the respective model comprises:
training the respective model using a training data set;
generating, for the respective model, a plurality of predictions based on an evaluation data set;
identifying, based on the plurality of predictions, from the evaluation data set, for the respective model, a subset of correctly predicted data and a subset of incorrectly predicted data;
wherein the training data set for a first model of the ensemble model comprises an initial training data set and the evaluation data set for the first model comprises the initial training data set and a testing data set; and
wherein the training data set and the evaluation data set for each model of the ensemble model other than the first model comprises the subset of incorrectly predicted data of a last generated model of the ensemble model.

9. The computer system of claim 8, wherein repeatedly generating the respective model comprises repeatedly generating the respective model until a termination condition is satisfied.

10. The computer system of claim 8, wherein the operations further comprise calculating, for each model of the ensemble model, a corresponding statistical distribution of the subset of correctly predicted data.

11. The computer system of claim 10, wherein the operations further comprise identifying, for an input data set, a particular model of the ensemble model having the corresponding statistical distribution of the subset of correctly predicted data with a highest similarity to a statistical distribution of the input data set.

12. The computer system of claim 11, wherein the operations further comprise generating output based on the input data set by providing the input data set as input to the particular model.

13. The computer system of claim 8, wherein generating the respective model comprises:
determining that an amount of data in the subset of incorrectly predicted data falls below a threshold amount of data for use as training data; and
adding, to the subset of incorrectly predicted data, at least a portion of synthetic data.

14. The computer system of claim 13, wherein the at least a portion of synthetic data is based on a statistical distribution of the subset of incorrectly predicted data.

15. A computer program product comprising:
one or more computer readable storage media; and
program instructions stored on the one or more storage media to perform operations comprising:
generating an ensemble model comprising a plurality of models by repeatedly generating a respective model for inclusion in the ensemble model, wherein generating the respective model comprises:
training the respective model using a training data set;
generating, for the respective model, a plurality of predictions based on an evaluation data set;
identifying, based on the plurality of predictions, from the evaluation data set, for the respective model, a subset of correctly predicted data and a subset of incorrectly predicted data;
wherein the training data set for a first model of the ensemble model comprises an initial training data set and the evaluation data set for the first model comprises the initial training data set and a testing data set; and
wherein the training data set and the evaluation data set for each model of the ensemble model other than the first model comprises the subset of incorrectly predicted data of a last generated model of the ensemble model.

16. The computer program product of claim 15, wherein repeatedly generating the respective model comprises repeatedly generating the respective model until a termination condition is satisfied.

17. The computer program product of claim 15, wherein the operations further comprise calculating, for each model of the ensemble model, a corresponding statistical distribution of the subset of correctly predicted data.

18. The computer program product of claim 17, wherein the operations further comprise identifying, for an input data set, a particular model of the ensemble model having the corresponding statistical distribution of the subset of correctly predicted data with a highest similarity to a statistical distribution of the input data set.

19. The computer program product of claim 18, wherein the operations further comprise generating output based on the input data set by providing the input data set as input to the particular model.

20. The computer program product of claim 15, wherein generating the respective model comprises:
determining that an amount of data in the subset of incorrectly predicted data falls below a threshold amount of data for use as training data; and
adding, to the subset of incorrectly predicted data, at least a portion of synthetic data.
